(19) United States
(12) Patent Application Publication
(10) Pub. No.: US 2019/0249965 A1
(43) Pub. Date: Aug. 15, 2019

(54) SELF-REMOVING RANGE ANIMAL INJECTION APPARATUS

(71) Applicant: Gene WIART, Ponoka (CA)

(72) Inventor: Gene WIART, Ponoka (CA)

(21) Appl. No.: 15/898,096

(22) Filed: Feb. 15, 2018

(51) Int. Cl. F42B 12/54; A61D 7/00

(52) U.S. Cl. CPC F42B 12/54; A61D 7/00

(57) ABSTRACT

A range animal injection apparatus has a syringe, a pressure chamber, a needle and a self-removal system which may include a contact member positioned only on one side of the needle and projections extending from an end of the dart. When the apparatus hits an animal the contact member is pushed back opening a valve at the needle end of the syringe. Pressure in the pressure chamber acts on the plunger of the syringe pushing medication into the animal. The plunger eventually closes the valve and moves the contact member forward to remove the apparatus from the animal. Pinching is reduced by the contact member being positioned below and not around the needle. The projections help keep the dart relatively perpendicular to the hide reducing pinching and increasing leverage. The projections also reduce rotation of the apparatus, helping to keep the contact member below the needle.

### TECHNICAL FIELD

Self-removing syringes for providing medication to animals.

### BACKGROUND

In U.S. Pat. No. 5,437,641, a retrieval system for an animal injection apparatus is described. Although in that patent the main embodiment described is referred to as an “arrow”, in this document the term “dart” will be used to encompass both “arrow” and “dart” and carries no implication as to delivery method.

The system as described in U.S. Pat. No. 5,437,641, shown in FIGS. 1 and 2, works as follows: a dart 12 is launched towards an animal. The dart has a shaft 14 and includes a syringe at a first end 16 of the dart. The syringe has a syringe chamber 20 and has a needle 28 with a first end 30 and a second end 32 at a front end of the dart. A valve 10 prevents flow of medication 38 from the syringe chamber through the needle when the needle is not penetrating an animal. When the dart hits the animal the needle penetrates into the animal's hide. The dart also has a contact member 48 at the front end. As the needle penetrates the animal's hide, the contact member contacts the animal's hide and is pressed back relative to the needle. The contact member is connected via a rigid coupling 50 to a valve member 46. As the contact member moves back relative to the needle, it moves the valve member into the syringe chamber, opening the valve and allowing medication to flow from the syringe chamber through the needle into the animal. The medication is under pressure supplied via a plunger 24 activated by air pressure in pressure chamber 22 at a second end 18 of the dart. Pressure chamber 22 is sealed at the second end of the dart by a plug 34 with self-sealing passage 36. As the medication exits the syringe into the animal, the plunger moves toward the front end of the syringe chamber. The plunger eventually comes into contact with the valve member and pushes the valve member forward to block passage 44, closing the valve. This also pushes the contact member forward, pushing on the animal's hide to remove the dart from the animal. Thus, in ideal operation of the system, the dart remains in the animal while the medication is flowing into the animal, and promptly falls away from the animal for retrieval once the medication has been delivered.

The system as described above has been generally successful, but more reliability is desired. In particular, sometimes the animal's hide becomes pinched between the needle and the contact member, preventing the dart from promptly dropping away from the animal once the medication has been delivered.

### SUMMARY

There is provided a self-removing range animal injection apparatus. It may include a dart having a syringe with a plunger, a pressure source acting on the plunger, a needle at a first end of the dart and defining a longitudinal direction, the needle being in fluid communication with the syringe, a contact member movable in the longitudinal direction, the contact member being offset from the needle in a second direction perpendicular to the longitudinal direction, and the contact member not extending around the needle, a valve member connected to the contact member and positioned to be contacted by the plunger, the valve member being configured to open an opening connecting the syringe to the needle when the contact member is moved towards the syringe, and close the opening and move the contact member away from the syringe when the plunger contacts the valve member.

In various embodiments, there may be included any one or more of the following features: the contact member may be semi-circular. The contact member may have an indentation shaped to accommodate the needle. There may be projections extending from an end of the syringe. The projections may extend radially from the syringe.

There is also provided a self-removing range animal injection apparatus including a dart having a syringe with a plunger, a pressure source acting on the plunger, a needle at a first end of the dart, and defining a longitudinal direction, the needle being in fluid communication with the syringe, a contact member movable in the longitudinal direction, a valve member connected to the contact member, member and positioned to be contacted by the plunger, the valve member being configured to open an opening connecting the syringe to the needle when the contact member is moved towards the syringe, and close the opening and move the contact member away from the syringe when the plunger contacts the valve member, and projections extending from an end of the syringe.

In various embodiments, there may be included any one or more of the following features: the contact member may be semi-circular. The contact member may have a groove shaped to receive the needle. The projections may be shaped as fins extending radially from the syringe. The needle may have a grip portion. The contact member may be offset from the needle in a second direction perpendicular to the longitudinal direction and not extend around the needle.

These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 shows a cross section view of a prior art range animal injection apparatus with the valve in an open position as the apparatus is loaded with a dose of medication.

FIG. 2 shows a cross section view of the prior art range animal injection apparatus of FIG. 1 with the valve in a closed position while a pressure source upstream of the valve is pressurized.

FIG. 3 is a cross section view of a range animal injection apparatus with the valve in an open position.

FIG. 4 is a cross section view of the range animal injection apparatus of FIG. 3 with the valve in a closed position.

FIG. 5 is a front-end view of the range animal injection apparatus of FIG. 3 with projections.

FIG. 6 is a cross section view of the range animal injection apparatus of FIG. 3 with the valve in a closed position after medication is administered to an animal, showing flights at a second end of the dart.

### DETAILED DESCRIPTION

Immaterial modifications may be made to the embodiments described here without departing from what is covered by the claims.

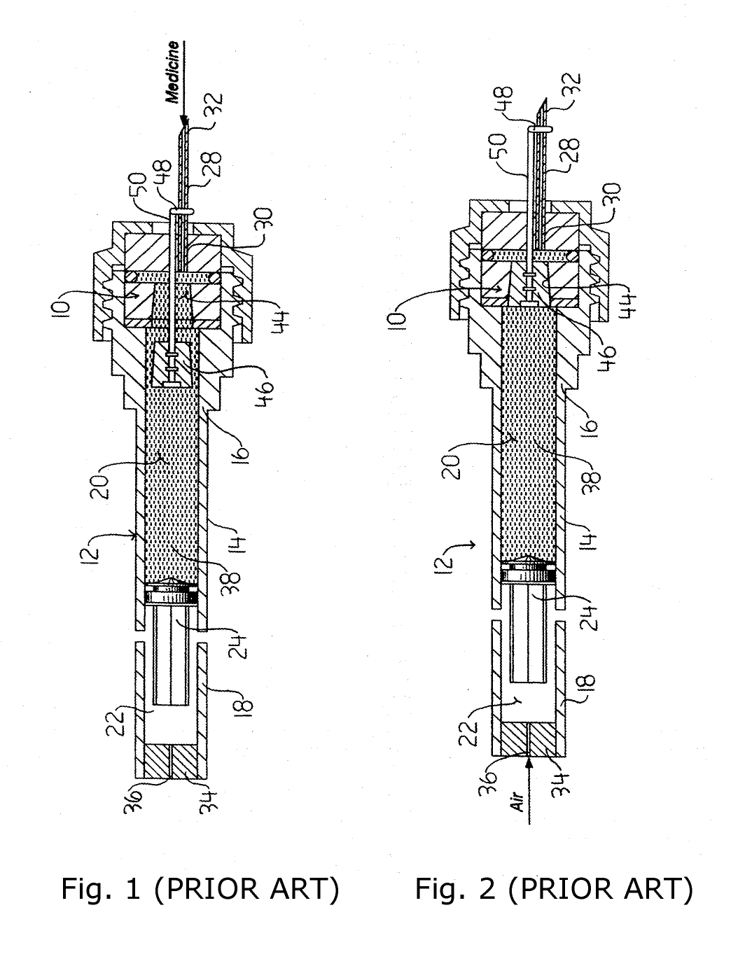

FIGS. 1 and 2, taken from U.S. Pat. No. 5,437,641, show a prior art range animal injection apparatus which functions as described above.

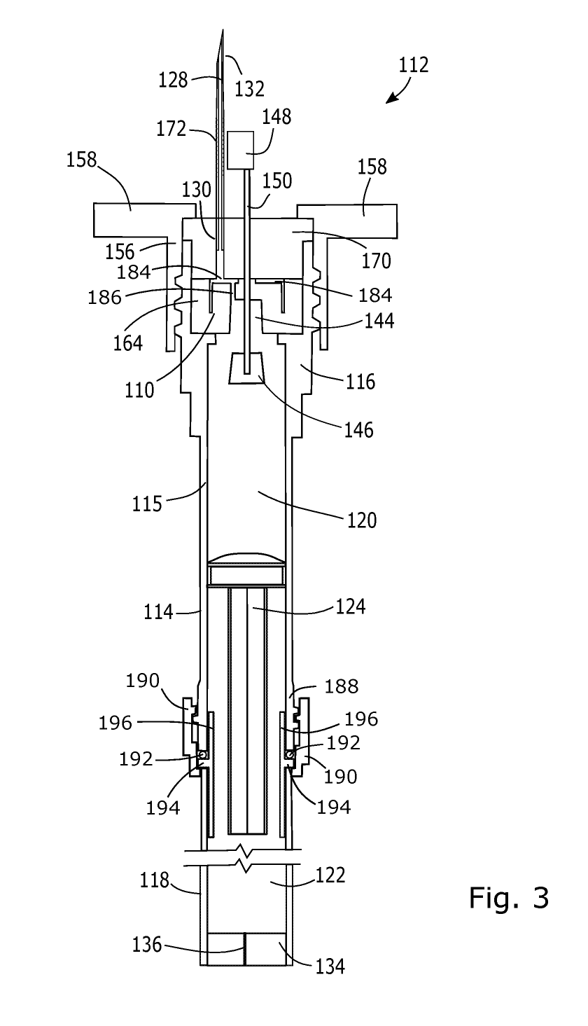

Referring to FIG. 3, self-removing range animal injection apparatus 112 consists of a dart. In a preferred embodiment, the dart is configured to be shot from a crossbow. The dart could be made larger and mounted on a pole or made smaller and shot from a dart gun.

The dart has a shaft 114 with a syringe 115 positioned at a first end 116 of the shaft. A needle 128 is secured to the first end 116 of the shaft. Needle 128 has a first end 130 and a second end 132. First end 130 of the needle communicates with a syringe chamber 120. Second end 132 projects past first end 116 of shaft 114. Syringe 115 may be threadably connected to the pressure chamber.

Shaft 114 has a hollow internal cavity forming pressure source chamber 122. A plug 134 is disposed at second end 118 of shaft 114 with a self-sealing passage 136 therethrough. Passage 136 is adapted to receive a needle valve (not shown) so that air can be pumped into pressure chamber 122. This pressurized air within pressure chamber 122 acts upon a plunger 124 of the syringe 115. When a pressure imbalance is created between syringe chamber 120 and pressure chamber 122, plunger 124 will move to compress syringe chamber 120. This forces liquid medication from syringe chamber 120 through needle 128.

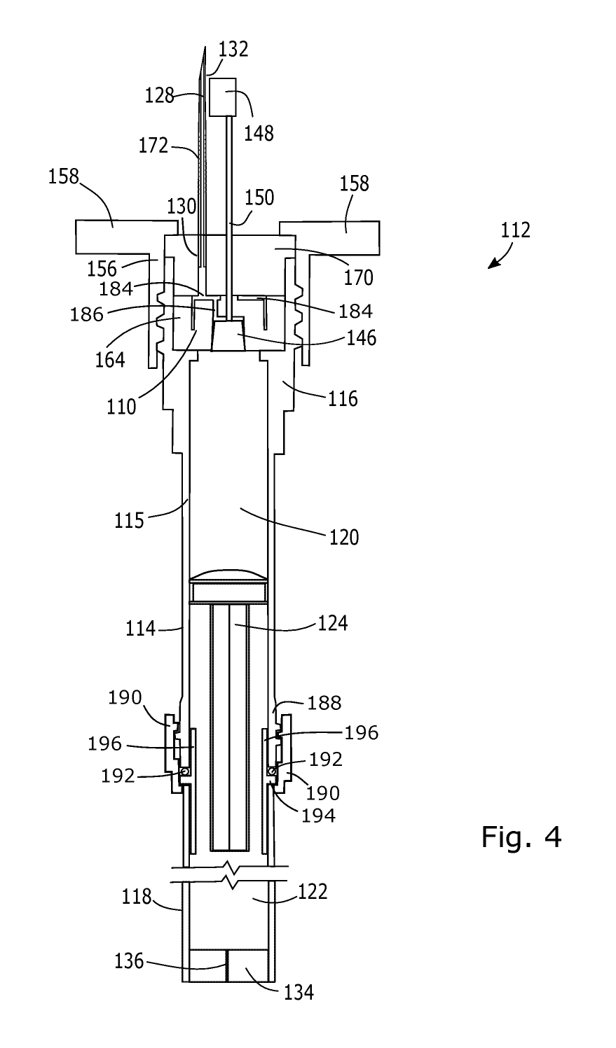

The self-removal system for a range animal apparatus includes a valve 110 positioned adjacent first end 130 of needle 128. The valve 110 may include a valve seat member 164 defining, passage 144 and a pressure sensitive valve member 146 movable axially in relation to passage 144 between an open position and a closed position. In the open position, illustrated in FIG. 3, valve member 146 is spaced from passage 144 thereby allowing the free flow of liquids from syringe chamber 120 to needle 128. In the closed position, illustrated in FIG. 4, valve member 146 is lodged in passage 144 thereby creating a fluid-tight seal and precluding the flow of liquids from syringe chamber 120 to needle 128. To create a fluid-tight seal the valve seat member 164 and/or the valve member 146 may be formed of flexible material and the valve member 164 may be tapered with a maximum circumference slightly larger than the maximum circumference of the passage 144.

A contact member 148 is movable axially in relation to needle 128 between first end 130 and second end 132 of the needle. A rigid coupling 150, which may be a rod, couples the movement of contact member 148 and valve member 146. Rigid coupling 150 may extend into a hole 198 in the contact member adapted to receive the rigid coupling 150. Rigid coupling 150 may be threadably connected to valve member 146. In an embodiment, contact member 148 is preferably positioned so the contact member is below the needle when the needle is inserted into the animal. The contact member is positioned at or near a center axis of the shaft of the dart and the needle is positioned to one side relative to the center axis of the dart. The contact member is then positioned below the needle by the user when the dart is fired. If the contact member is positioned above or around the needle when the needle is in the animal, the contact member may pinch the fur or hide of the animal, preventing or inhibiting removal of the dart from the animal. Positioning the contact member below the needle allows the dart to more reliably fall away from the animal after the medication is delivered.

The syringe 115 may be rotatably connected to the second end 118 of the shaft. As shown in FIG. 3, second end 118 has a tubular connector 196 fixed to the second end 118 and shaped to fit within end 188 of the syringe. An annular seal 192 rests against tab 194 of the tubular connector 196 to prevent air leakage from the pressure chamber. Connector 190 is threadably connected to an end 188 of the syringe to secure the syringe to the pressure chamber. The connector 190 and end 188 of the syringe can be rotated with respect to the second end 118 of the shaft allowing the user to rotatably adjust the position of the contact member relative to the second end 118 of the dart. When the threaded connection between connector 190 and end 188 of the syringe is tightened, tab 194 may be moved towards second end 188 of the syringe, squeezing annular seal 192 and preventing rotation of the syringe with respect to second end 118 while the threaded connection is tightened.

Flights 200 may be positioned at the second end 118 of the shaft to stabilize the flight of the dart. In order for the user to orient the syringe more easily to position the contact member below the when the dart is used, the flights may be asymmetric or differentially coloured and the user may be instructed to align the contact member and needle in a known orientation with respect to the flights. The flights may act as a guide to aligning the dart. As shown in FIG. 6, two flights may be positioned 180 degrees relative to each other around the shaft of the dart. There may be a third flight (not shown) positioned between the two flights, for example at 90 degrees around the shaft from the other flights. The third flight may be differently coloured than the other two flights.

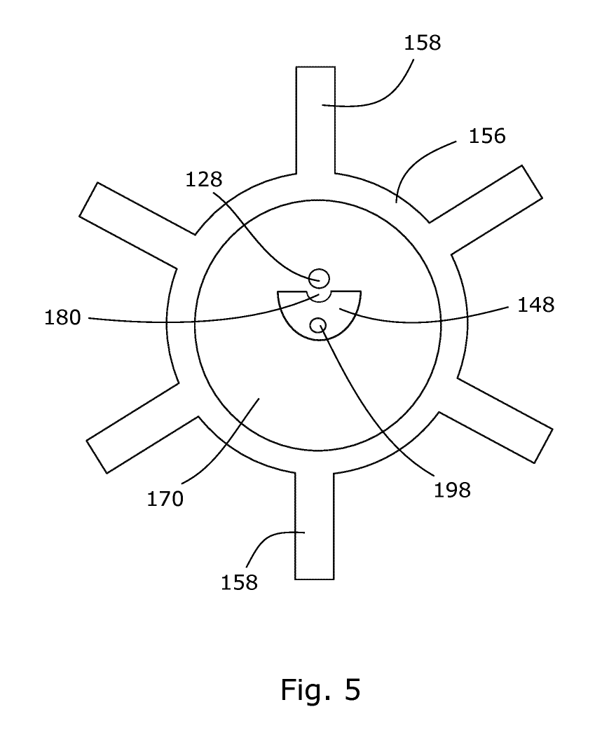

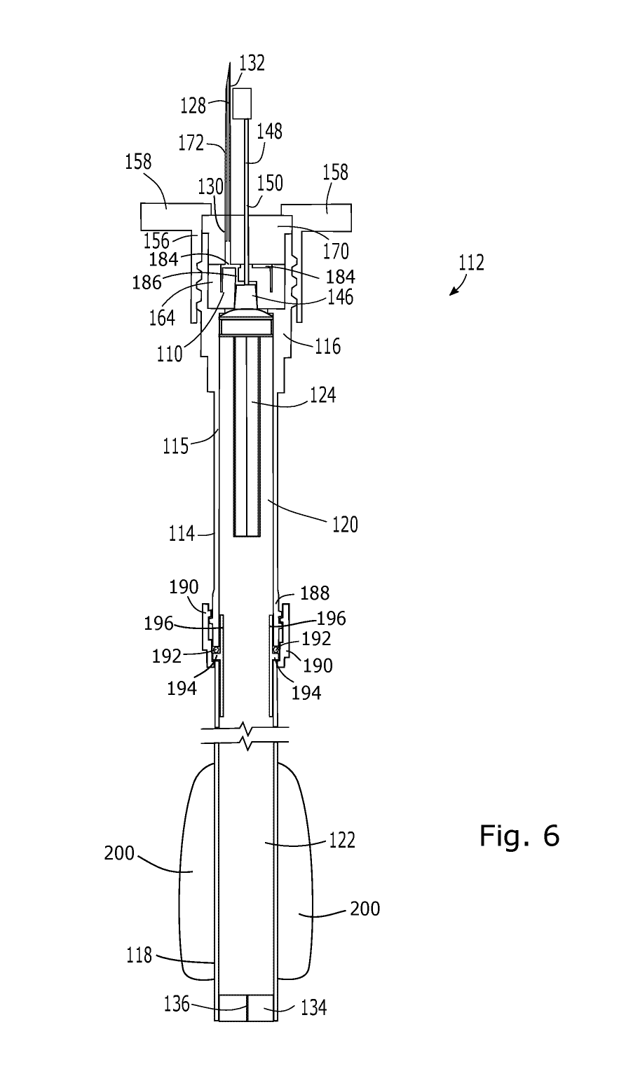

Contact member 148 may be any shape, for example substantially semi-circular as shown in FIG. 5, and may have an indentation 180 shaped to accommodate the needle. However, preferably the contact member does not extend around the needle, the indentation 180 being adjacent to only one side of the needle. The contact member is preferably positioned less forward than the tip of the needle so that if the dart hits the animal reasonably close to perpendicular to the hide of the animal so that the needle will hit the hide before the contact member.

When valve 110 is in the closed position with valve member 146 positioned in passage 144, contact member 148 is positioned away from first end 116 of the shaft. When valve 110 is in the open position with valve member 146 spaced from passage 144, contact member 148 is positioned closer to first end 116 of the shaft.

First end 116 of shaft 114 may be threadably connected to an end cap 156. Valve 110 has an annular spacer 164 that has passage 144 extending therethrough. The needle preferably may be in fluid communication with the syringe regardless of the needle's circumferential position relative to the annular spacer. The annular spacer 164 has a fluid passage 186 connecting passage 144 to annular cavity 184. A needle mounting disk 170 is provided to secure needle 128.

In an embodiment, end cap 156 may have projections 158 extending from the end cap. The projections may extend radially and/or axially from the end cap. Radial projections 158 provide leverage to prevent the shaft from dropping against the animal when the needle is inserted into the hide of the animal. This may help prevent pinching as pinching risk is increased by the needle being aligned with the animal's hide, for example due to the shaft dropping. The projections preferably help to maintain a relatively perpendicular orientation of the shaft to the hide of the animal and prevent the dart from twisting axially relative to the animal. This helps maintain the orientation of the contact member below the needle while the needle is in the animal's hide. For example, the projections may be shaped as radial fins as shown in FIG. 5. The projections may also help to stabilize the dart during flight. The length of the fins can be varied depending on the desired increase in leverage. The needle may have a grip portion 172, for example formed of circumferential grooves, to help prevent the needle from sliding out of the animal's hide while the medication is being delivered. The grip portion preferably does not extend forward beyond the position of the contact member when the contact member is extended, so that the contact member pushes the animal's hide away from the grip portion after the medication is delivered. The additional leverage provided by the radial projections tends to make it easier for the needle 128 to slide out of the animal's hide; to keep the dart in place long enough for the medication to be injected into the animal the needle may be provided with a grip portion 172 with greater grip than would otherwise be used, for example larger circumferential grooves 172.

Both having the contact member positioned below the needle and including projections on the end cap aid in the removal of the dart from the animal. Both features or either of the features alone may be present in the self-removal system. When present together, the projections work synergistically with the positioning of the contact member, helping to keep the flight of the dart stable and maintaining the position of the contact member relative to the needle.

To fill syringe chamber 120 with medication, valve 110 is placed into the open position by exerting a force upon contact member 148 until contact member 148 moves toward first end 130 of needle 128 thereby pushing valve member 146 out of passage 144. Medication may then be inserted through needle 128 into syringe chamber 120. A force is then exerted upon contact member 148 until the valve is closed, as illustrated in FIG. 4. This draws valve member 146 into passage 144, placing valve 110 into the closed position. A needle valve (not shown) may then be inserted into self-sealing passage 136 of rubber plug 134. Air is then pumped through self-sealing passage 136, for example using a bicycle pump, to pressurize pressure chamber 122. Due to the presence of movable plunger 124 disposed between pressure chamber 122 and syringe chamber 120; the pressurization of pressure chamber 122 places medication in syringe chamber 120 under equal pressure with pressure chamber 122. When needle 128 enters the hide of an animal, contact member 148 is pushed toward first end 130 of needle 128 by the hide. Needle 128, as illustrated, is a needle best suited for intra-muscular injections. It will be appreciated that by modifying needle 128 subcutaneous injections can be achieved. As contact member 148 moves, valve member 146 is also moved until valve 110 is in the open position. Once valve 110 is in the open position a differential in pressure is created as between syringe chamber 120 and pressure chamber 122. Pressure chamber 122 remains under pressure, whereas the pressure in syringe chamber 120 is released via needle 128. The greater air pressure within pressure chamber 122 causes plunger 124 to move toward the first end 116 of the dart, shortening the length of syringe chamber 120 and sending liquid medication in syringe chamber 120 past open valve member 146 along passage 144 and through needle 128 until liquid medication has vacated syringe chamber 120. The plunger eventually contacts the valve member 146 and pushes the valve member forward into passage 144, closing the valve, as shown in FIG. 6. Due to the presence of rigid coupling 150, the movement of valve member 146 serves to move contact member 148 toward second end 132 of needle 128 until contact member 148 pushes needle 128 out of the hide of the animal.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A self-removing range animal injection apparatus; comprising:
a dart having a syringe with a plunger;
a pressure source acting on the plunger;
a needle at a first end of the dart and defining a longitudinal direction, the needle being in fluid communication with the syringe;
a contact member movable in the longitudinal direction, the contact member being offset from the needle in a second direction perpendicular to the longitudinal direction, and the contact member not extending around the needle;
a valve member connected to the contact member and positioned to be contacted by the plunger, the valve member being configured to open an opening connecting the syringe to the needle when the contact member is moved towards the syringe, and close the opening and move the contact member away from the syringe when the plunger contacts the valve member.

2. The self-removing range animal injection apparatus of claim 1 in which the contact member is semi-circular.

3. The self-removing range animal injection apparatus of claim 1 in which the contact member has an indentation shaped to accommodate the needle.

4. The self-removing range animal injection apparatus of claim 1 further comprising projections extending from an end of the syringe.

5. The self-removing range animal injection apparatus of claim 4 in which the projections extend radially from the syringe.

6. A self-removing range animal injection apparatus; comprising:
a dart having a syringe with a plunger;
a pressure source acting on the plunger;
a needle at a first end of the dart, and defining a longitudinal direction, the needle being in fluid communication with the syringe;
a contact member movable in the longitudinal direction;
a valve member connected to the contact member, member and positioned to be contacted by the plunger, the valve member being configured to open an opening connecting the syringe to the needle when the contact member is moved towards the syringe, and close the opening and move the contact member away from the syringe when the plunger contacts the valve member; and
projections extending from an end of the syringe.

7. The self-removing range animal injection apparatus of claim 6 in which the contact member is semi-circular.

8. The self-removing range animal injection apparatus of claim 6 in which contact member has an indentation shaped to accommodate the needle.

9. The self-removing range animal injection apparatus of claim 6 in which the projections extend radially from the syringe.

10. The self-removing range animal injection apparatus of claim 6 in which the contact member is offset from the needle in a second direction perpendicular to the longitudinal direction and does not extend around the needle.
